(19) United States
(12) Patent Application Publication
(10) Pub. No.: US 2026/0066148 A1
(43) Pub. Date: Mar. 5, 2026

(54) TECHNIQUES FOR DETECTION OF RYDBERG EXCITATIONS IN QUANTUM INFORMATION PROCESSORS

(71) Applicant: ColdQuanta, Inc., Boulder, CO (US)

(72) Inventors: Woo Chang Chung, Boulder, CO (US); Daniel C. Cole, Superior, CO (US)

(73) Assignee: ColdQuanta, Inc., Boulder, CO (US)

(21) Appl. No.: 19/313,852

(22) Filed: Aug. 28, 2025

Related U.S. Application Data
(60) Provisional application No. 63/688,046, filed on Aug. 28, 2024.

(51) Int. Cl. G21K 1/00; G06N 10/40; G06N 10/70

(52) U.S. Cl. CPC G21K 1/30; G06N 10/40; G06N 10/70

(57) ABSTRACT

Techniques are described for deterministically returning Rydberg atoms from a Rydberg state to a ground state. These techniques allow for improved calibration of Rydberg excitations, and for detection of errors without the loss of atoms from traps described above. In particular, the techniques comprise applying a pulse to a Rydberg atom to transition the atom from a Rydberg state to a second state having a lower energy than the Rydberg state. These pulses, referred to here as “drain pulses,” are selected to produce the desired transition to the second state, referred to herein as a “drain state.” The drain state may be selected as a state that will decay, or which may be driven, to a ground state. Accordingly, the drain pulse provides a path for atoms to transition from a Rydberg state to a ground state.

### CROSS-REFERENCE TO RELATED APPLICATION

The present application claims the benefit under 35 U.S.C. § 119 (e) of U.S. Provisional Patent Application No. 63/688,046, filed on Aug. 28, 2024, titled “Efficient Detection of Rydberg Excitation of Atoms,” which is hereby incorporated by reference in its entirety.

### BACKGROUND

Quantum computing platforms promise to provide solutions to many computationally intractable problems. In a quantum computing platform, information is stored in quantum bits or “qubits,” and the power of the platform generally increases with the number of qubits that can be independently and simultaneously controlled. In quantum computing platforms comprising qubits such as trapped ions or neutral atoms, directed electromagnetic waves (e.g., microwaves, optical beams) implement independent qubit manipulations, while platforms comprising qubits such as electron dots or superconducting rings use guided RF or microwave beams.

Quantum information processing with neutral atoms offers many exciting opportunities. Neutral atoms can be trapped in flexible geometries and in large numbers using optical trapping techniques. Each individual atom can store a quantum bit of information in stable electronic energy levels, such as two hyperfine ground state energy levels. Such storage has the advantage of long coherence times, enabled by excellent isolation from the environment, near-perfect qubit initialization via optical pumping, individual optical readout of each qubit, and straightforward manipulation of single qubits.

### SUMMARY

According to some aspects, the techniques described herein relate to a method including: using a quantum information processor: applying, to a plurality of qubits, at least one Rydberg excitation pulse configured to drive the plurality of qubits between a Rydberg state and an initial sublevel of a first ground state manifold of the plurality of qubits; applying, to the plurality of qubits subsequent to applying of the at least one Rydberg excitation pulse, a drain pulse configured to drive the plurality of qubits between the Rydberg state and a drain state having a lower energy than the Rydberg state; measuring a relative state population of the first ground state manifold and a second ground state manifold of the plurality of qubits; and adjusting at least one calibration parameter of the at least one Rydberg excitation pulse based on the relative state population.

According to some aspects, the techniques described herein relate to a method including: using a quantum information processor: performing an entangling gate including applying, to a plurality of qubits, at least one Rydberg excitation pulse configured to drive the plurality of qubits between a Rydberg state and an initial sublevel of a first ground state manifold of the plurality of qubits; applying, to the plurality of qubits subsequent to applying of the at least one Rydberg excitation pulse, a drain pulse configured to drive the plurality of qubits between the Rydberg state and a drain state having a lower energy than the Rydberg state, wherein applying the drain pulse causes at least some state population of each of the plurality of qubits to be in qubit states and; and performing, subsequent to applying the drain pulse, at least one quantum error correction operation on the qubit states and of the plurality of qubits.

According to some aspects, the techniques described herein relate to a system including: an optical system configured to trap, and manipulate quantum states of, a plurality of neutral atom qubits; and at least one controller configured to: apply, to the plurality of neutral atom qubits, at least one Rydberg excitation pulse configured to drive the plurality of neutral atom qubits between a Rydberg state and an initial sublevel of a first ground state manifold of the plurality of neutral atom qubits; apply, to the plurality of neutral atom qubits subsequent to applying of the at least one Rydberg excitation pulse, a drain pulse configured to drive the plurality of neutral atom qubits between the Rydberg state and a drain state having a lower energy than the Rydberg state; measuring a relative state population of the first ground state manifold and a second ground state manifold of the plurality of neutral atom qubits; and adjusting at least one calibration parameter of the at least one Rydberg excitation pulse based on the relative state population.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic of a neutral atom quantum information processor, according to some embodiments;

FIGS. 2A-2E depict a process of operating the neutral atom quantum information processor of FIG. 1, according to some embodiments;

FIG. 3A depicts energy levels of a neutral atom, according to some embodiments;

FIG. 3B depicts Rabi oscillations of a neutral atom, according to some embodiments;

FIG. 4 depicts illustrative energy levels of a neutral atom, according to some embodiments;

FIG. 5 depicts an illustrative process of detecting Rydberg errors, according to some embodiments;

FIG. 6 depicts a timing diagram depicting application of a concatenated pulse, according to some embodiments;

FIG. 7A is a flow chart of a method of calibration Rydberg excitation pulses in a quantum information processor, according to some embodiments;

FIG. 7B is a flow chart of a method of correcting Rydberg errors in a quantum information processor, according to some embodiments; and

FIG. 8 illustrates an example of a computing system environment on which aspects of the disclosure may be implemented.

### DETAILED DESCRIPTION

Rydberg states of atoms are highly excited states where one or more electrons are greatly displaced from the nucleus and have extreme sensitivities to external electric fields from the environment and other Rydberg atoms. Such extreme sensitivity (high electric polarizability) has inspired many applications of Rydberg atoms for quantum technologies such as quantum sensing and quantum computing.

For example, some entangling gates between a pair of neutral atoms may be performed by applying a series of Rydberg pulses to either or both atoms. During application of this series of pulses, either or both of the atoms can be excited to a Rydberg state, but at the end of the series it is desirable that both atoms are no longer in the Rydberg state. For example, one version of the CZ gate comprises Rydberg pulses that are applied to a first qubit, then a second qubit, then the first qubit again.

In some cases, however, an error may occur during application of the gate that leaves an atom in a Rydberg state, or it may be desirable to perform an operation that may leave an atom in a Rydberg state as part of a calibration routine. For instance, imperfect calibration of pulse parameters or drifts in the calibration values, can make the Rydberg pulses unreliable. One approach to detecting such errors is to activate the optical traps that trap each atom. The optical traps are typically turned off during entangling operations because atoms in Rydberg states can be repelled by the optical traps (sometimes referred to as “antitrapping”), which can cause the atoms to be ejected from the trap. As such, subsequent to performing a multi-atom entangling gate, any atoms left in the Rydberg state as the result of an error will be antitrapped when the trap is turned back on. This phenomenon can allow detection of the errors because only the atoms that were undesirably left in the Rydberg state should be ejected, and therefore detecting which traps are empty indicates which atoms were left in an error state.

While this lossy detection of Rydberg excitation often provides a clear signal, it requires replenishment of lost atoms for repeated measurements. Hence, the overall measurement time is longer, and the complexity of the experimental control flow increased. In addition, the unwanted loss of atoms that were not returned to a ground state during a multi-atom entanglement procedure contributes error in neutral-atom-based quantum computation schemes. Moreover, this error cannot be corrected by standard quantum error correction techniques, which are most mature for bit- or phase-flip errors that leave atoms in one of the qubit states. Attempting to use multiple Rydberg pulses to return atoms to a qubit state may result in an unpredictable mix of atoms in ground and Rydberg states, since unitary dynamics cannot be made one-way.

The inventors have recognized and appreciated techniques for deterministically returning Rydberg atoms from a Rydberg state to a ground state. These techniques allow for improved calibration of Rydberg excitations, and for detection of errors without the loss of atoms from traps described above. In particular, the techniques comprise applying a pulse to a Rydberg atom to transition the atom from a Rydberg state to a second state having a lower energy than the Rydberg state. These pulses, referred to here as “drain pulses,” are selected to produce the desired transition to the second state, referred to herein as a “drain state.” The drain state may be selected as a state that will decay, or which may be driven, to a ground state. Accordingly, the drain pulse (and optionally, one or more additional pulses that transfer the state from the drain state to a ground state) provides a path for atoms to transition from a Rydberg state to a ground state.

According to some embodiments, one advantage of the techniques described herein is to allow an improved calibration of Rydberg pulses. In particular, the use of a ground state (e.g., one of the computational basis states |0 [symbol] and |1 [symbol] , or a superposition thereof) of a Rydberg atom to detect errors in the Rydberg pulse calibration may be preferable to using the Rydberg state via the lossy detection process described above, because the atoms that were in an error state are left in the traps and can be used in a subsequent operation. In contrast, the lossy detection process requires traps to be replenished where the atoms were in an error state, which is a relatively slow process.

According to some embodiments, another advantage of the techniques described herein is in detecting errors during operation (e.g., during execution of a quantum circuit). As described above, entangling gates may result in error states in which a Rydberg atom is left in a Rydberg state. These error states can be detected via the lossy detection process described above, but this would result in empty traps, which complicates possible correction of the error, as the trap must be reloaded. In contrast, the techniques described herein change an atom loss error into a state leakage error by converting any residual Rydberg state population into a ground state population.

Following below are more detailed descriptions of various concepts related to, and embodiments of, techniques for deterministically returning Rydberg atoms from a Rydberg state to a ground state. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

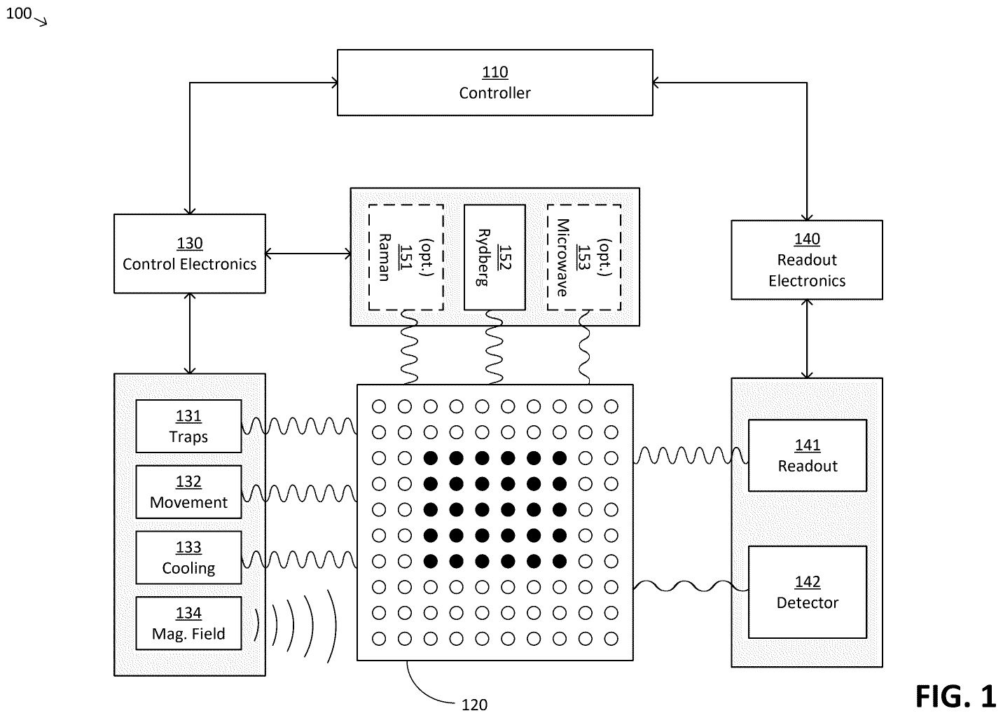

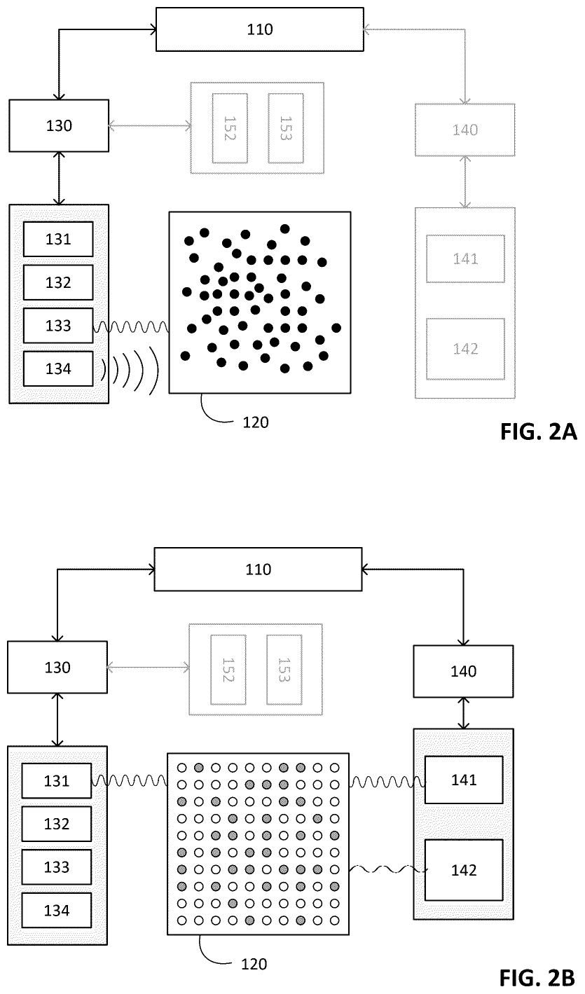

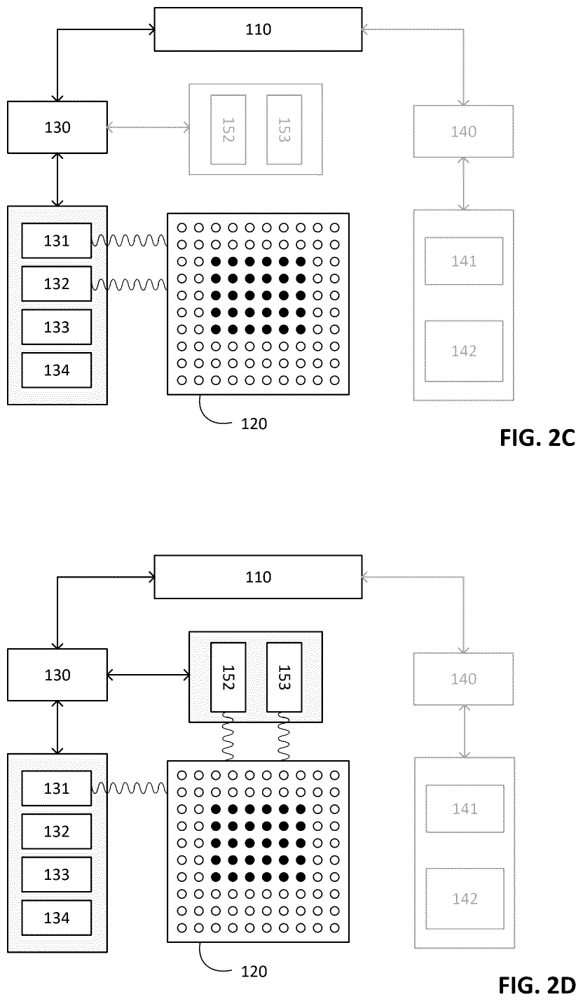

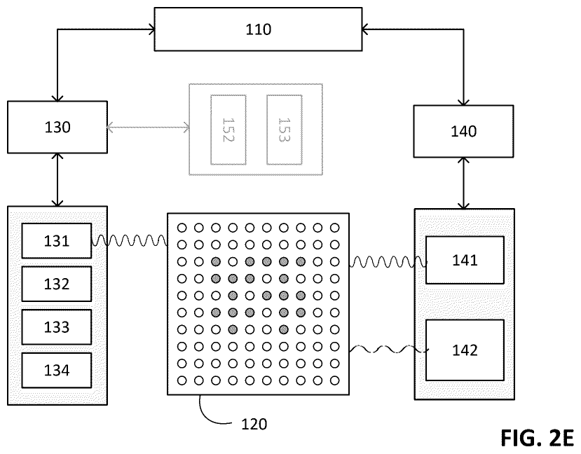

FIG. 1 is a schematic of a neutral atom quantum information processor, according to some embodiments. The illustrative quantum information processor 100 of FIG. 1 is provided as one example system in which the techniques described herein for deterministically returning Rydberg atoms from a Rydberg state to a ground state may be practiced. An example process of operating quantum information processor 100 is depicted in FIGS. 2A-2E, described below.

In the example of FIG. 1, quantum information processor 100 includes an array of neutral atoms 120, which are manipulated, and whose states are measured by, controller 110 via the control electronics 130 and/or readout electronics 140. In a neutral atom quantum information processor such as quantum information processor 100, the neutral atoms may be arranged in an array of traps, with a single atom in each trap. Typically, the atomic isotopes are chosen to have a convenient set of electronic quantum states that allow two such states to be used as computational basis states |0 [symbol] and |1 [symbol] , and that also include a Rydberg state |r [symbol] , which is an electronic state with a very high principal quantum number. The states of the atoms may be manipulated by applying electromagnetic pulses (e.g., laser light pulses of selected frequencies) to one or more selected neutral atoms. Logical gates may be performed by manipulating the quantum states of the neutral atoms, such as controlling transitions between the computational basis states |0 [symbol] and |1 [symbol] , allowing for arbitrary single-qubit gates. Entangling gates are performed by coupling one or both of the computational basis states |0 [symbol] and |1 [symbol] to the highly excited Rydberg state |r [symbol] , which produce desirable entangling interactions as a result of the Rydberg blockade effect, which inhibits two nearby atoms from occupying the Rydberg state. The neutral atoms 120 thereby operate as a type of qubit with respect to the computational basis states |0 [symbol] and |1 [symbol] , while also making use of the Rydberg state |r [symbol] . Manipulation of the quantum states of the neutral atoms 120 is described further below. Alternative schemes also exist in which more than two electronic quantum states are treated as computational basis states. For instance, with three computational basis states, the atom is referred to as a “qutrit”, with four states, a “ququart,” etc.

In the example of FIG. 1, the controller 110 may be configured to generate instructions that, when provided to and executed by, the control electronics 130 and readout electronics 140, perform various operations for control of the neutral atoms 120 as described below. The controller may be configured to generate such instructions using any suitable combination of software and/or hardware. According to some embodiments, controller 110 comprises software executed on a general-purpose processor, an application specific integrated circuit (ASIC), a field-programmable gate array (FPGA), and/or any other suitable controller suitable for controlling the quantum information processor via control electronics 130 and readout electronics 140. In the example of FIG. 1, controller 110 may be configured to receive signals from the control electronics 130 and readout electronics 140 and to generate, based on a received signal, one or more signals to send to either or both of control electronics 130 and readout electronics 140 by executing hardware and/or software logic.

In the example of FIG. 1, the control electronics 130 and readout electronics 140 may each be implemented using any suitable combination of software and/or hardware. In some embodiments, control electronics 130 and/or readout electronics 140 may be, or may comprise, a hardware controller such as an FPGA and/or ASIC.

In the example of FIG. 1, the control electronics 130 may be configured to provide signals to the trap system 131, the movement system 132, the cooling system 133, the magnetic field system 134, the Rydberg system 152, and optionally the Raman system 151 and the microwave system 153 (collectively, the “control systems”) according to instructions and/or other signals received from the controller 110. The control electronics 130 may be configured to receive signals from any one or more of the control systems and to send a signal or signals to any one or more of the control systems and/or to controller 110 in response to a received signal. For instance, the control electronics 130 may be configured to generate, based on a received signal, one or more signals to send to any one or more of the control systems, and/or to controller 110, by executing hardware and/or software logic. For instance, the control electronics 130 may comprise an FPGA programmed to output particular signals that will result in one or more of the control systems performing one or more actions, and may do so in response to one or more signals received from any part of the quantum information processor 100.

According to some embodiments, manipulation of the state of one or more of the neutral atoms 120 may be achieved through various techniques and mechanisms, and the illustrative control systems 151, 152 and 153 are depicted as examples. Some examples of operating these control systems are described below.

In the example of FIG. 1, the readout electronics 140 may be configured to provide signals to the readout system 141 and the detector 142 according to instructions and/or other signals received from the controller 110. The readout electronics 140 may be configured to receive signals from the readout system 141 and the detector 142, and to send a signal or signals to any one or more of the readout system 141, the detector 142, and/or controller 110 in response to a received signal. For instance, the readout electronics 140 may be configured to generate, based on a received signal, one or more signals to send to the readout system 141, the detector 142 and/or to the controller 110 by executing hardware and/or software logic. For instance, the readout electronics 140 may comprise an FPGA programmed to output particular signals that will result in the readout system 141 and/or the detector 142 performing one or more actions, and may do so in response to one or more signals received from any part of the quantum information processor 100.

Descriptions below relating to the quantum information processor 100 operating various elements of the system (e.g., Rydberg system 152) to perform particular operations, will be understood to refer to some combination of the control electronics 130 or readout electronics 140 providing signals to part of the quantum information processor, including but not limited to the above-noted control systems, readout system 141 and/or detector 142, whether in response to instructions and/or other signals received from the controller 110, or otherwise.

According to some embodiments, neutral atoms 120 comprises atoms of a Group I or Group II element, such as rubidium-87, cesium-133, or strontium-87. The neutral atoms may be provided as a low pressure gas (e.g., 10⁻⁸ Torr) of such atoms within a vacuum chamber. The neutral atoms 120 may be arranged in any suitable arrangement, including a two-dimensional (2D) or three-dimensional (3D) array, such as a 2D or 3D grid, by operating trap system 131 as described below.

In general, operation of the quantum information processor 100 comprises the following phases. Initially, the neutral atoms 120 are cooled then arranged in an array of traps with a single atom in each trap. This step typically also includes detecting the locations of atoms in the traps, and rearranging some atoms to produce a desired arrangement of atoms, such as the 2D grid array shown in FIG. 1. Subsequently, the quantum states of the atoms may be manipulated (e.g., to perform calculations or to perform calibration processes) through a series of operations that initialize the atoms in one of the two computational basis states |0 [symbol] and |1 [symbol] , or another desired state, and then manipulate the computational basis states |0 [symbol] and |1 [symbol] , the Rydberg state |r [symbol] , and/or any other desired state(s) of the atoms. The states of the atoms may then be measured after the operations to determine whether each atom is in the |0 [symbol] or |1 [symbol] state (although in practice there may be additional states that can, when measured, appear to the readout system as the |0 [symbol] or |1 [symbol] state; the act of measuring the states of the atoms will nonetheless generally be understood to have the goal of measuring the computational basis states).

FIGS. 2A-2E depict this process in more detail, according to some embodiments. In the example of FIGS. 2A-2E, the elements of FIG. 1 that are typically not operational in a given stage are shown greyed out for clarity. FIG. 2A represents an initial stage during which cooling system 133 and magnetic field system 134 are operated to cool and confine the neutral atoms within a desired volume.

According to some embodiments, cooling system 133 comprises one or more lasers configured to cool neutral atoms 120 to a temperature below 1 mK. For instance, cooling system 133 may operate via Doppler cooling in which a laser beam is directed onto an atom, with a frequency slightly below the resonance frequency of a particular electronic transition of the atom. The atoms will repeatedly absorb a photon of the light, losing momentum, and subsequently emit a photon in an arbitrary direction, gaining momentum. On average, because of the frequency detuning from the transition, this leads to a net momentum transfer opposite to the direction of the atom's movement, thereby reducing the speed of the atom. In some embodiments, the cooling system 133 may be configured to produce a plurality of laser beams along multiple different directions and which are configured to direct light onto the neutral atoms at a common frequency. For instance, the cooling system 133 may be configured to produce three pairs of laser beams along the directions of the six semi-axes of a 3D Cartesian coordinate system (e.g., optical molasses). In some embodiments, one or more laser beams produced by the cooling system 133, such as but not limited to the above example of three pairs of laser beams, may be circularly polarized. The cooling system 133 may be configured to produce multiple laser beams by operating multiple lasers and/or by operating suitable optical components to produce multiple laser beams from a single laser.

In some embodiments, the magnetic field system 134 comprises, or may otherwise operate, one or more magnetic field coils to produce a magnetic field within the region of the neutral atoms 120. In the examples of FIG. 1 and FIG. 2A, cooling system 133 is configured to generate a plurality of magneto-optical traps (MOTs) in part by operating the magnetic field system 134. In some embodiments, the magnetic field system 134 comprises two magnetic field coils in an anti-Helmholtz configuration and/or may be configured to produce a quadrupolar, spatially varying magnetic field. During operation, as shown in FIG. 2A, the magnetic field system 134 may be operated concurrently with the cooling system 133, thereby cooling the neutral atoms 120 via Doppler cooling using the cooling system 133, while also confining the atoms to a desired region in space.

Subsequent to or during cooling of the neutral atoms, in the example of FIG. 1 and FIG. 2B, trap system 131 may be operated to produce a plurality of traps within the space in which the neutral atoms are confined by the magnetic field system 134. The traps produced by the trap system 131 may include magnetic and/or optical traps. In some embodiments, the trap system 131 is configured to generate one or more optical tweezers (which may comprise one or more focused laser beams) that can trap one or more individual atoms by attracting an atom to an intensity maximum of light. In some embodiments, the trap system 131 is configured to generate one or more optical bottle beams (which may comprise one or more focused laser beams) that can trap one or more individual atoms by repelling an atom from an intensity maximum of light (so that an atom is trapped in comparatively darker regions between the beams). In some implementations, trap system 131 may be configured to produce both one or more optical tweezers and one or more optical bottle beams. In some embodiments, the trap system 131 is configured to produce a 2D or 3D array (e.g., a 2D or 3D grid) of traps by generating an array of optical tweezers by generating an array of focused laser beams. In some embodiments, the trap system 131 comprises one or more spatial light modulators (SLMs) that may be operated to produce traps in arbitrary positions (e.g., by generating one or more optical tweezers). Typical distances between individual traps may in some embodiments be between 1 μm and 10 μm, such as approximately 2 μm.

In some embodiments, trap system 131 comprises one or more acousto-optic deflectors (AODs) that may be operated to produce one or more traps. AODs deflect an incident laser beam into multiple beams, where the deflection angle of each beam is controlled by the acoustic wave frequencies applied to the deflector. Continuously varying the frequencies changes the deflection angles of the laser beams, reconfiguring the beams in one dimension to form traps with the beams. In some embodiments, the trap system 131 includes one or more AODs in addition to one or more SLMs. In at least some cases, traps produced by AODs may be more easily moved than traps produced by SLMs, though may have constraints on their positioning.

In some embodiments, trap system 131 may be configured to produce an optical lattice. For instance, the trap system 131 may comprise one or more acousto-optic modulators (AOMs), which may be operated to produce a spatially periodic polarization pattern that may be used to trap neutral atoms.

Frequently, not all of the traps produced by the trap system 131 will trap an atom. In some embodiments, the quantum information processor 100 may be configured to detect which of the traps contain an atom, and in response to move atoms that are detected to produce a desired arrangement of the atoms within traps. As shown in the example of FIG. 2B, the readout system 141 and detector 142 may be operated together to detect the positions of atoms within the traps produced by the trap system 131 by operating the readout system to illuminate the neutral atoms (e.g., with visible light), and detecting a result of said illumination with the detector.

In some embodiments, the readout system 141 is configured to illuminate the neutral atoms 120 with an imaging beam, such as a laser-scanning imaging beam. In some embodiments, the readout system 141 is configured to produce light with a wavelength selected to cause fluorescence of the neutral atoms 120 (e.g., a wavelength corresponding to an optical transition). The detector 142 may be configured to detect locations at which fluorescence light was produced, so that, for example, atoms are visible as bright spots, and empty traps are visible as dark spots. In the case of the neutral atoms 120 being rubidium-87 atoms, for example, the imaging beam may include light with a wavelength of 780 nm to cause fluorescence of the rubidium-87 atoms.

In some embodiments, the detector 142 comprises an optical imaging device, such as a charge coupled device (CCD), a complementary metal-oxide semiconductor (CMOS) imaging device, or an electron multiplying CCD (EMCCD) optical camera. In some embodiments, the detector 142 comprises an array of single-pixel photodetectors. In some embodiments, the detector 142 comprises a high numerical aperture (e.g., NA >0.3) lens that focuses light onto an imaging device.

Subsequent to detecting which traps contains atoms as shown in FIG. 2B, the atoms that are present may be rearranged by operating the movement system 132 and the trap system 131, as shown in FIG. 2C. For instance, the controller 110 may provide signals (e.g., data comprising or otherwise indicating executable instructions) to the readout electronics 140 that, when executed by the readout electronics, operate the readout system 141 to illuminate the neutral atoms, and to operate the detector 142 to produce imaging data indicating the positions of atoms present in the traps. The readout electronics 140 may receive the imaging data (or other data indicating the positions of atoms in the traps) and may send one or more signals to the controller 110 indicating the positions of the atoms (e.g., the imaging data or other data indicative of the positions). The controller 110 may be configured to determine a series of operations to be performed by the movement system 132 to rearrange the detected atoms, and may provide signals (e.g., data comprising or otherwise indicating executable instructions) to the control electronics 130 that, when executed by the control electronics, operate the movement system 132 and/or the trap system 131 to move one or more atoms into a new position.

There are various techniques by which atoms can be moved from a trap in one location to a trap in another location. In some embodiments, the movement system 132 is configured to operate one or more SLMs, which are producing the traps, to shift the locations of one or more of the traps, thereby carrying an atom in that trap to a new location.

In some embodiments, such translations can be produced by operating the SLM to add defocus to a trap, which will shift the focus and thereby shift the trap. An alternative approach is to operate the SLM or another light source to illuminate an atom with counter-propagating beams of light with the same frequency, so that they form a standing wave. When the frequency of one of the beams is changed, the standing wave moves, carrying the atom along with it. The adjusted beam is returned to its original frequency to halt the atom transportation.

In some embodiments, the quantum information processor 100 includes traps produced by one or more AODs and the AODs may be operated to move atoms between traps. In some embodiments, the quantum information processor 100 includes traps produced by an optical tweezer (e.g., generated by one or more SLMs as described above) and traps produced by one or more AODs, and the optical tweezer and AODs may be operated to transfer atoms between the two types of traps, and to shuttle atoms around between the optical tweezer traps by adjusting the AODs to move the trap array. In some embodiments, the quantum information processor 100 may comprise one or more arbitrary waveform generators (AWGs) configured to control one or more AODs to move atoms (irrespective of whether quantum information processor 100 also includes traps produced by an optical tweezer).

Irrespective of how the atoms are rearranged, the result is a register of neutral atoms held in traps in a desired arrangement, such as the 2D array shown in FIG. 2C. Subsequently, quantum operations may be performed on the neutral atom register, including operations for calculation and/or calibration. The operation of the quantum information processor 100 to perform such operations is shown in FIG. 2D, and generally include applying laser and/or microwave pulses to one or more of the atoms to manipulate the quantum state of the one or more atoms.

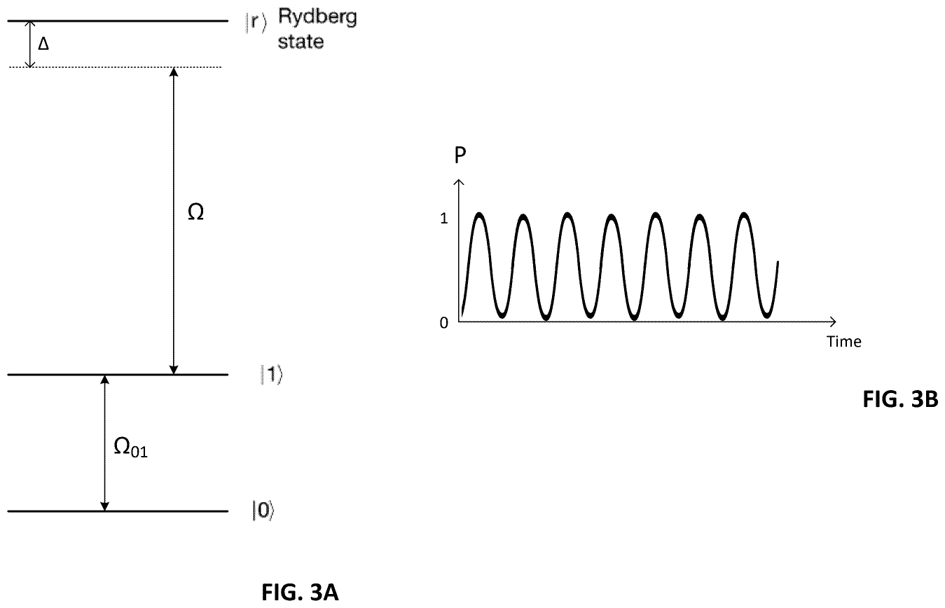

As shown in FIG. 3A, the quantum states of interest for the type of neutral atom in quantum information processor 100 include the energy levels selected to represent the computational basis states |0 [symbol] and |1 [symbol] , and the highly excited Rydberg state |r [symbol] . Driving fields applied to a neutral atom that are at or close to resonance between a pair of these energy levels excite coherent oscillations between those states, also called Rabi oscillations. The Rabi oscillations are oscillations of quantum mechanical amplitudes and expectation values of level populations, rather than discrete processes of absorption and emission of photons. The oscillating amplitudes indicate the probability of finding the atom in a certain state when the state is measured, as shown in FIG. 3B, which depict the oscillating probability of measuring the atom to be in a particular electronic state after a driving field is applied for a given amount of time. The probability shown may for example, be the probability of measuring the atom to be in the state |1 [symbol] , or the probability of measuring the atom to be in the state |r [symbol] . When the driving field is applied for a fraction of a period at the frequency of oscillation (the Rabi frequency), the atom may be placed in a superposition of states, which may be seen in FIG. 3B since the probability lies between 0 and 1 except for whole or half periods of the oscillations. In addition, a level of detuning of a driving field from a transition frequency (e.g., transition frequency Ω₀₁) will alter the Rabi frequency of the oscillations. As such, adjusting the frequency of the driving field will also adjust the quantum operation performed by the driving field. In general, a desired superposition between a pair of states can be produced by selecting the frequency, duration, intensity and/or phase of the driving field appropriately.

Transitions between the |0 [symbol] and |1 [symbol] states can, in some approaches, be driven by microwave pulses. The atoms in optical traps are generally too close together for a microwave pulse to be focused on a single atom, but microwave pulses can drive transitions between the states for a plurality of atoms (which may include all of the neutral atoms 120, or a portion thereof). In other approaches, a transition between the |0 [symbol] and | 1 [symbol] states of a single atom (or a plurality of atoms) can be driven optically by driving Raman transitions. In the example of FIG. 1, the optional Raman system 151 is configured to be operated to drive such transitions between the |0 [symbol] and |1 [symbol] states.

According to some embodiments, the optional Raman system 151 is configured to operate two phase-locked lasers with a frequency difference equal to the frequency difference between the |0 [symbol] and |1 [symbol] states, Ω₀₁. In this approach, the computational basis states |0 [symbol] and | 1 [symbol] are effectively coupled via excitation to a higher energy state. Such lasers generated by the Raman system 151 may be focused on one or more neutral atoms as desired, for instance by operating one or more AOMs and/or AODs.

In some embodiments, the Raman system 151 is configured to direct a global Raman beam onto all (or at least a plurality of) the neutral atoms 120, and is additionally configured to direct a secondary Raman beam onto one or more neutral atoms as desired, such that the |0 [symbol] and | 1 [symbol] states in a given neutral atom are coupled only when both Raman beams are directed onto the atom. By activating and deactivating (or adjusting the direction of) the secondary Raman beam onto a neutral atom, the coupling may be turned on and off. In some cases, both Raman beams may be produced by the same laser, and arranged with suitable optical components to produce the separate beams.

In some embodiments, the optional microwave system 153 is configured to direct a global microwave pulse onto all (or at least a plurality of) the neutral atoms 120, and a source of electromagnetic radiation (e.g., Raman system 151, Rydberg system 152 or otherwise) is configured to direct a beam, such as a Stark shifting beam, onto one or more neutral atoms as desired, such that the |0 [symbol] and |1 [symbol] states are coupled for an atom only when the microwave pulse and the beam are both directed onto the atom.

In some embodiments, the microwave system 153 and the Rydberg system 152 (or a part thereof) may be configured to drive single-qubit operations of the neutral atoms 120. In particular, the microwave system 153 may be operated to perform one type of single-qubit operation on all, or on a large number of the neutral atoms 120, and another source of electromagnetic radiation (e.g., Rydberg system 152 or a part thereof) may, at other times, drive another type of single-qubit operation of individual neutral atoms. For instance, in some embodiments the microwave system 153 is configured to perform global qubit rotations around equatorial axes in the Bloch sphere, and the Rydberg system 152 is configured to direct a beam onto one or more individual qubits to perform rotations around the Z axis in the Bloch sphere. By performing some ordered combination of either or both of these two types of operations, an arbitrary single-qubit gate on any individual neutral atom can be realized. As described below, the Rydberg system 152 may be configured to direct laser light at two different wavelengths onto a neutral atom to drive transitions between the |1 [symbol] and |r [symbol] states. In some cases, the rotations around the Z axis on single qubits may be performed by directing laser light having one of the two different wavelengths onto a neutral atom.

In the illustrative example of FIGS. 2A-2E, the optional Raman system 151 is not included, and single qubit gates are performed using the above-described approach of operating the microwave system 153 to perform one type of single-qubit operation on all, or on a large number of the neutral atoms 120, and operating the Rydberg system 152 or a part thereof to drive another type of single-qubit operation of individual neutral atoms.

In some embodiments, the Raman system 151 is configured to produce a frequency-modulated laser beam that is modulated to produce low-noise sidebands at the frequency difference between the |0 [symbol] and |1 [symbol] states, and subsequently passed through a dispersive element, thereby producing an amplitude-modulated beam that couples the two states.

In some embodiments, the Raman system 151 is configured to produce a global pulse that couples the |0 [symbol] and |1 [symbol] states for the purposes of applying the same operation to all of the neutral atoms. In such configurations, the Raman system 151 may also be configured in any one or more of the above ways to couple the |0 [symbol] and |1 [symbol] states in individual atoms.

According to some embodiments, the Raman system 151 may comprise one or more AWGs configured to be operated in conjunction with a laser source to shape pulses of Raman beams, and/or to configure pulses through in-phase and quadrature (“IQ”) control of the source.

In the example of FIG. 1, transitions between the |1 [symbol] and |r [symbol] states, which are for instance relied upon when performing entangling gates, are controlled by Rydberg system 152. In some embodiments, the Rydberg system 152 is configured to direct laser light at two different wavelengths onto one or more neutral atoms to couple the |1 [symbol] and |r [symbol] states. For example, the Rydberg system 152 may be configured to direct a bichromatic laser beam onto one or more neutral atoms to couple the |1 [symbol] and |r [symbol] states. As one example, for rubidium-87 atoms, the Rydberg system 152 may be configured to direct a bichromatic laser beam comprising 420 nm light and 1013 nm light onto one or more neutral atoms.

In some embodiments, the Rydberg system 152 is configured to direct laser light at one frequency onto all (or at least a plurality of) the neutral atoms 120, and is additionally configured to direct a secondary Rydberg beam onto one or more neutral atoms as desired, wherein activating and deactivating the secondary Rydberg beam turns the coupling between the |1 [symbol] and |r [symbol] states on and off. As one example, for rubidium-87 atoms, the Rydberg system 152 may be configured to direct a 1013 nm laser beam onto all of the neutral atoms, and to selectively direct pulses of a secondary laser beam at 420 nm onto one or more neutral atoms. The laser light directed onto all (or a plurality of) the neutral atoms may also be activated and deactivated over the time period of one or more operations, with the secondary Rydberg beam providing finer timing control over activation and deactivation of the coupling (e.g., the 1013 nm laser beam is directed onto all the neutral atoms for a time period in which one or more Rydberg excitations are performed, and during that period, the secondary Rydberg beam is turned on and off several times).

The Rydberg system 152 may be operated to direct any of the above laser beams onto neutral atoms at least in part by operating one or more AOMs and/or AODs to address individual atoms, pairs of atoms, or other groups of atoms.

According to some embodiments, one or more of the neutral atoms may be moved between traps in between quantum operations to ensure arbitrary connectivity between the neutral atoms. Such movement may be performed by operating the movement system 132 as described above in relation to FIG. 2C.

Subsequent to any number of manipulations of any number of the neutral atoms by the Rydberg system 152 and/or microwave system 153 as shown in FIG. 2D, the quantum information processor 100 may be operated to measure states of the neutral atoms with respect to the computational basis states |0 [symbol] and |1 [symbol] .

In some embodiments, the quantum information processor 100 may be configured to eject neutral atoms from the traps conditionally based on their state, and operate the readout system 141 and detector 142 to detect the remaining neutral atoms, thereby measuring the state of each of the neutral atoms. For instance, the quantum information processor 100 may be configured to eject neutral atoms from the traps when the neutral atoms are in the |1 [symbol] state and to retain the neutral atoms in the traps otherwise, then to detect in which traps neutral atoms remain. The detected remaining atoms after ejection of the other neutral atoms in this example may be determined to have been measured in the |0 [symbol] state. Such a process may also be performed in which neutral atoms are ejected conditionally on being in the |0 [symbol] state, thereby retaining neutral atoms in the |1 [symbol] state. In some embodiments, the trap system 131 may be operated during such a process to adjust the depth of the potential wells of the traps (e.g., to make the traps deeper).

According to some embodiments, the quantum information processor 100 may operate Raman system 151 and/or Rydberg system 152 to direct a resonant laser pulse that “blows away” atoms in either of the states |0 [symbol] or |1 [symbol] . In the example of FIG. 1 and FIG. 2E, the readout system 141 is configured to illuminate the neutral atoms 120 with an imaging beam subsequent to directing a resonant laser pulse to blow away atoms in either of the states |0 [symbol] or |1 [symbol] . The detector 142 may be configured and operated as described above to detect locations at which fluorescence light was produced.

In some embodiments, the quantum information processor 100 may be configured to perform non-destructive readout of the neutral atoms 120 by operating the readout system 141 and detector 142 to measure the state of each of the neutral atoms. In particular, the readout system 141 may be configured to illuminate the neutral atoms 120 with an imaging beam that causes the neutral atoms to fluoresce in different ways depending on their state. For instance, the imaging beam may cause only atoms in one of the states to fluoresce, or may cause atoms in one state to fluoresce in a different way (e.g., at a different intensity or at a different wavelength) from atoms in the other state. The detector 142 may be configured and operated as described above to detect fluorescence produced from the neutral atoms in this manner.

According to some embodiments, the quantum information processor 100 may include a variety of hardware and optical elements for directing, transmitting, modifying, focusing, dividing, modulating, and amplifying generated light fields to various shapes, sizes, profiles, orientations, polarizations, and intensities, as well as any other desirable properties. Some illustrative optical elements such as SLMs, AODs and AOMs have been described above. The quantum information processor 100 may also include other optical elements, such as various beam splitters, beam shapers, shapers, diffractive elements, refractive elements, gratings, mirrors, polarizers, modulators and so forth. While particular examples of operating hardware and optical elements are provided above with respect to particular elements of quantum information processor 100 shown in FIG. 1, it will be appreciated that multiple elements in FIG. 1 may share the same hardware and/or optical elements, and there is no requirement that such hardware and optical elements are separated into distinct units as shown in FIG. 1. For instance, the same SLM or AOD could be operated by multiple ones of the systems shown in FIG. 1 (e.g., the same AOD could be operated by the trap system 131 and by the Raman system 151).

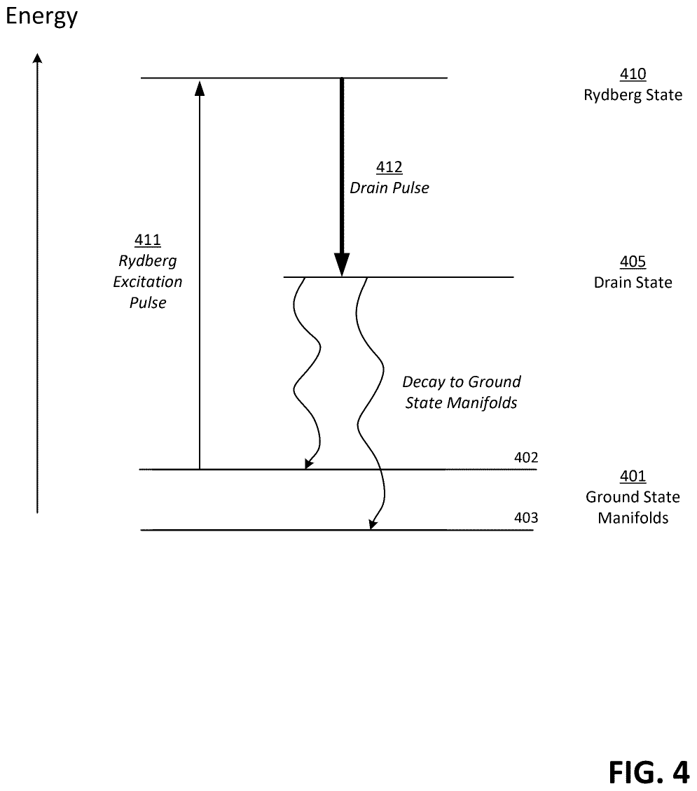

As described above, techniques described herein provide for deterministically returning Rydberg atoms from a Rydberg state to a ground state through application of a drain pulse. FIG. 4 depicts an illustrative set of energy levels for purposes of further illustration, according to some embodiments.

In the example of FIG. 4, several energy levels of an illustrative atom are depicted. In particular, ground state manifolds 401 are shown, which represent multiple different stable states of the lowest energy states of an electron within the atom. These different states are all energetically very close to the lowest energy level. For example, if the illustrated atom were ¹³³Cs, the ground state manifolds may include the various Zeeman states of the F=3 and F=4 hyperfine manifolds of the 6S_{1/2} energy level, with the higher energy depicted ground state manifold 402 representing the F=4 manifold, and the lower energy depicted ground state manifold 403 representing the F=3 manifold.

In operation of the techniques described herein, an illustrative sequence of lossless Rydberg state detection is as follows. The atom is prepared to be in a state (e.g. a ground state) that is amenable to Rydberg excitation. Rydberg excitation pulse(s) and drain pulse(s) are executed. The target atom then has probability amplitudes in the ground state, the drain state, and possibly other truly trappable states from which the drain state probability amplitude is being transferred or “streamed”. The drain state is “streamed” to the initial ground state and/or another ground state(s) either by spontaneous emission that happens naturally or by another control pulse (laser or microwave). That the drain state probability amplitude does not fully go back to the initial ground state allows the states to be discriminated.

FIG. 4 also depicts a Rydberg state 410, which is a state to which the atom may be excited through application of a Rydberg excitation pulse 411, as described above. An atom may be prepared in an initial state, which is one of the states within the ground state manifolds (e.g., the ground state manifold 402 in the example of FIG. 4). As one example, if the illustrated atom were ¹³³Cs, the initial state may be the m_{F}=0 state of the F=4 hyperfine manifold of the 6S_{1/2} energy level. The Rydberg excitation produced by Rydberg excitation pulse 411 may represent a single-photon or multiple-photon (e.g., two-photon) excitation from the ground state manifold 402 to the Rydberg state 410. For example, if the illustrated atom were ¹³³Cs, the Rydberg excitation pulse may be a two-photon Rydberg excitation pulse that excites the atom from an initial ground state in the ground state manifold 402 (6S_{1/2}, F=4) to a Rydberg energy level 66S_{1/2}.

FIG. 4 further depicts drain state 405, to which the atom may be driven from the Rydberg state 410 through application of drain pulse 412. The drain state decays to one of the ground state manifolds 401 via spontaneous emission as depicted, although the decay process from the drain state to the ground state manifolds can take place over multiple steps involving intermediate states not shown in FIG. 4. As one example, if the illustrated atom were ¹³³Cs, the drain state may be the F′=4′ hyperfine manifold of the 7P_{1/2} energy level. It will be appreciated that, in practice, the state population may not be fully driven to the drain state 405 from the Rydberg state 410 before part of the state population decays to the ground state manifolds.

After a state population in the drain state 405 decays to a state population in the ground state manifolds 401, the probability amplitude of states in the initial ground state (i.e., the state that was previously driven by the Rydberg excitation pulse) can be discriminated from probability amplitudes in other ground states by state-sensitive detection. For example, by operating an optical system as described above to cause fluorescence of neutral atoms, a large amount of fluorescence may be produced by atoms in states in one manifold and comparatively little (or no) fluorescence produced by atoms in states in the other manifold.

In the example of a ¹³³Cs atom, for instance, the contrast in the state discrimination comes from the difference between the highly uneven distribution between the F=4 and the F=3 manifolds prior to the Rydberg excitation and the relatively even distribution after the drain pulse and the transfer of the drain state to both manifolds. Additional manipulation can increase the contrast of this discrimination. In the example of Cs¹³³, atoms are illuminated by a “repumper” laser pulse so that all transferred probability amplitudes from the drain state end up in the F=4 manifold (the manifold to which the initial ground state belongs in this example). However, the distribution of the “repumped” probability amplitudes among the ground states within the F=4 manifold is approximately uniform. Thus, only a small fraction of the final probability amplitudes arrives at the initial ground state. After a microwave pulse transfers the probability amplitude in the initial ground state in the F=4 manifold to another Zeeman level in the F=3 manifold, the state discrimination contrast, which still comes from the difference between the total populations in the F=4 manifold and the F=3 manifold respectively, is enhanced. This contrast may be enhanced because only the population transfer from the Rydberg excitation and drain pulse sequence contributes to the F=4 manifold population (assuming no initial state preparation and microwave pulse error) and it has a small crosstalk contribution to the F=3 manifold. State discrimination contrast as high as 80%, which is sufficient for a high signal-to-noise-ratio calibration of Rydberg excitation pulses, may be achieved by this sequence.

It may be noted that, while the drain state 405 is depicted in FIG. 4 as having a lower energy than the Rydberg state 410, in some cases an atom may be driven to another, higher energy Rydberg state (e.g. by a pulse of microwave or laser radiation) from which a drain pulse drives a transition to the drain state. As such, the drain pulse may drive the atom between a first Rydberg state and the drain state 405, whereas the Rydberg excitation pulse 411 drives the atom between the ground state manifold 402 and the Rydberg state 410. In such cases, it may be possible that the first Rydberg state has a higher energy than the Rydberg state 410, and may further be the case that the drain state 405 has a higher energy than the Rydberg state 410 but a lower energy than the first Rydberg state. Such an arrangement may be useful because, due to atomic selection rules, there may be more convenient drain states available from one Rydberg state than from another.

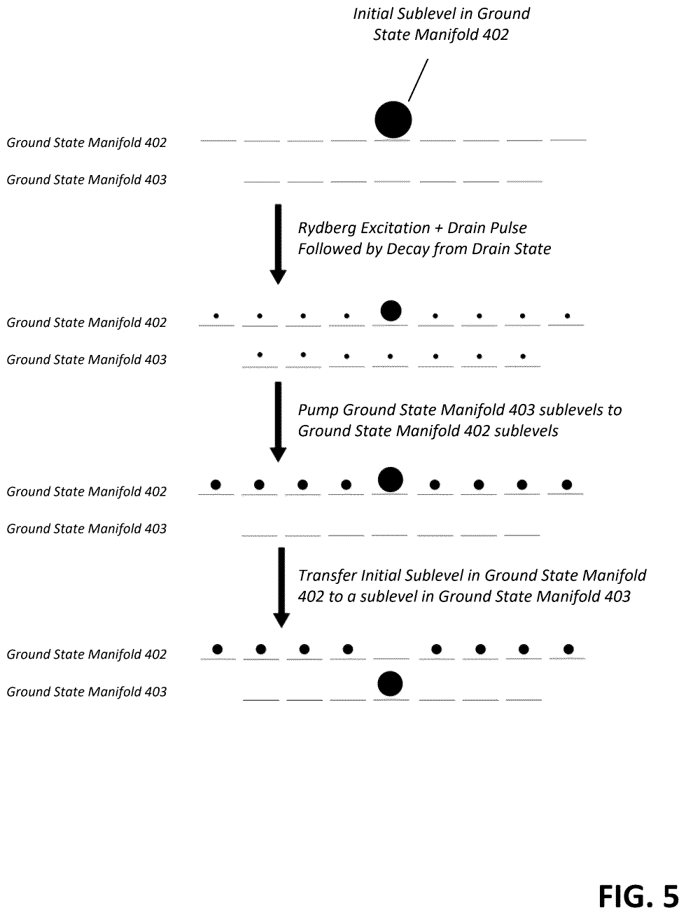

FIG. 5 depicts an illustrative example of the above process for a neutral atom, according to some embodiments. In the example of FIG. 5, the thin horizontal lines in the figure denote different sublevel states in the ground state manifolds. The dark filled circles represent probability or equally square of probability amplitude magnitudes associated with each sublevel state. The relative sizes of the filled circles show the distribution of the probabilities of occupying various sublevel states.

As depicted in FIG. 5, the atom is first prepared in an initial sublevel within ground state manifold 402. For example, in the example of Cs¹³³, the initial state may be prepared in the m_{F}=0 Zeeman sublevel of the F=4 hyperfine manifold of the 6S1/2 energy level.

Subsequently, the Rydberg excitation pulse and drain pulse are applied, as shown in FIG. 4, and spontaneous emissions from the drain state occur, leading to the arrangement shown in the second subfigure of FIG. 5, which depicts the resulting energy states. As shown, the probability in the initial state has decreased and probabilities in other states have increased slightly. In this example, the Rydberg excitation pulse was short enough that a significant population was left in the initial sublevel state. In practice the distribution of population across ground-state Zeeman sublevels after drain decay will not be uniform as shown, but this simplification allows for clarity of description and does not qualitatively affect operation of the technique.

Subsequently, the ground state manifold 403 is pumped to the ground state manifold 402 (e.g., by a repumping laser), leading to the arrangement shown in the third subfigure of FIG. 5. For example, in the example of Cs¹³³, the sublevels in the F=3 manifold may be pumped to various F=4 sublevels.

Subsequently, a suitable control (e.g., a microwave pulse) drives a transition from the initial sublevel state (i.e., the sublevel state in which the atom was arranged in the first subfigure) to a sublevel state in the ground state manifold 402.

The result of this process is that most of the probability amplitude that was left in the Rydberg state after the Rydberg pulse ends up in the ground state manifold 402, having passed through the drain state to one of the ground state manifolds as intermediate stages, as shown in the fourth subfigure of FIG. 5. In contrast, the probability amplitude that remained in the ground state during the Rydberg pulse or that was returned to the ground state after the Rydberg pulse, before the drain pulse, ends up in ground state manifold 403. The resulting contrast between the total populations in the respective hyperfine manifolds as detected by a state-selective detection is proportional to the difference between the initial state population and the Rydberg state population immediately after the Rydberg excitation pulse. In some embodiments, this may assume a negligible atom loss from the Rydberg state prior to the drain pulse.

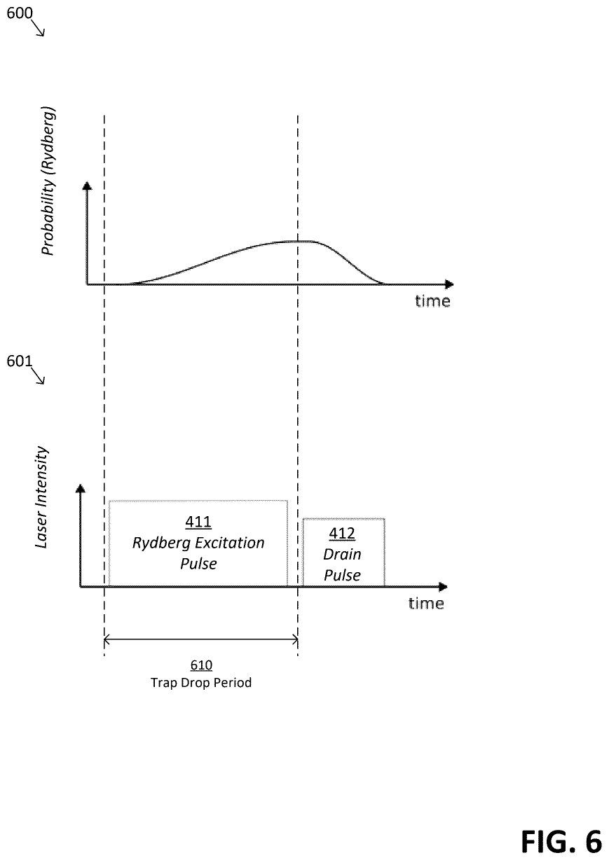

FIG. 6 depicts a process of applying a Rydberg excitation pulse followed by a drain pulse, according to some embodiments. The combination of the Rydberg excitation pulse followed by a drain pulse may also be referred to herein as a “concatenated pulse.”

In the example of FIG. 6, the probability of the atom being in a Rydberg state (P_{Rydberg}) during a concatenated pulse (i.e. a Rydberg pulse followed by a drain pulse) is depicted in graph 600. The relative timing of the laser pulses 411 and 412 are shown in graph 601. After Rydberg excitation pulse 411, the square of the magnitude of the probability amplitude in the target Rydberg state grows to some non-zero value. Subsequently, the drain pulse 412 reduces P_{Rydberg} to a comparatively much smaller value. The target atom may have a non-zero probability of being in the drain state after the drain pulse. This drain state may provide a low quantum state carrier (e.g. atom) loss rate.

According to some embodiments, there may be certain characteristics of the drain state (i.e. the atomic state to which atoms transition in response to the drain pulse) that provide advantages. For example, the drain state is desired to have a low loss rate. To have such a low loss rate, the drain state does not need to be trappable. For instance, atoms are either repelled from, or attracted to, the point of maximum laser intensity depending on the AC polarizability of the atomic state at the wavelength of the trapping laser. Assuming the atoms are trapped when they occupy the qubit states, “trappable” states may be those that have the same sign of the AC polarizability at the trap wavelength as the qubit states, and therefore are attracted to or repelled from the trapping laser in the same way as the qubit states.

An anti-trapped drain state may have an effectively low loss rate if it quickly decays or is transferred by another set of lasers (e.g. via additional pulse(s)) to another set of states that are trappable). In at least some cases, Rydberg states may not be practical drain states themselves because they are meta-stable: they decay eventually to trappable states, but generally not quickly enough before their anti-trapping tendency repels them from the trapping potential far away so that the atom survival probability at the time of complete transfer to trapped states is low. The more excited a Rydberg state is (possessing higher quantum number), the higher its sensitivity to external electric field and hence more useful for the aforementioned quantum technology applications, but the longer its natural lifetime becomes. The anti-trapping problem is thus exacerbated.

FIG. 6 also depicts a trap drop period 610 during which an optical trap may be deactivated. According to some embodiments, a neutral atom quantum information processor may from time-to-time perform trap drops in which an optical trap that traps a qubit is deactivated temporarily (or otherwise reduced in power). Problematically, light from an optical trap used to trap neutral atoms can interfere with Rydberg operations and/or with Rydberg interactions between atoms, degrading their reliability and utility. To address this problem, the trap light can be temporarily turned off or “dropped” (e.g., modulated so that it no longer traps the atoms) for a short time, then turned back on to recapture the atoms. Any operations involving a Rydberg interaction can be performed during the “trap drop” period during which the trap light is temporarily turned off or otherwise reduced in power.

Accordingly, the trap drop period 610 may be configured to begin before the Rydberg excitation pulse 411 and end after the Rydberg excitation pulse 411 has completed. In the example of FIG. 6, the trap drop period 610 ends before, or around the start of, the drain pulse 412. It may be advantageous not to lengthen a trap drop period to make room for the drain pulse 412, as this could cause issues such as heating of spectator atoms or the atom participating in Rydberg excitation, for example. In addition, the optimal frequency of the laser applying the drain pulse may be dependent on the presence/absence of the trap light, and it is preferable to use a single frequency such that it is preferable that the drain pulse is applied after the end of the trap drop period. Having said that, the anti-trapping/loss process may be relatively slow compared to the time it takes to turn the trap back on and apply the drain pulse. Accordingly, even if the drain state is not trappable, turning the trap back on prior to applying the drain pulse 412 may not significantly lead to ejection of atoms in the drain state. Put another way, the drain state may decay to a trappable state on a timescale that is much faster than the timescale at which an untrappable state would be expelled from the trap.

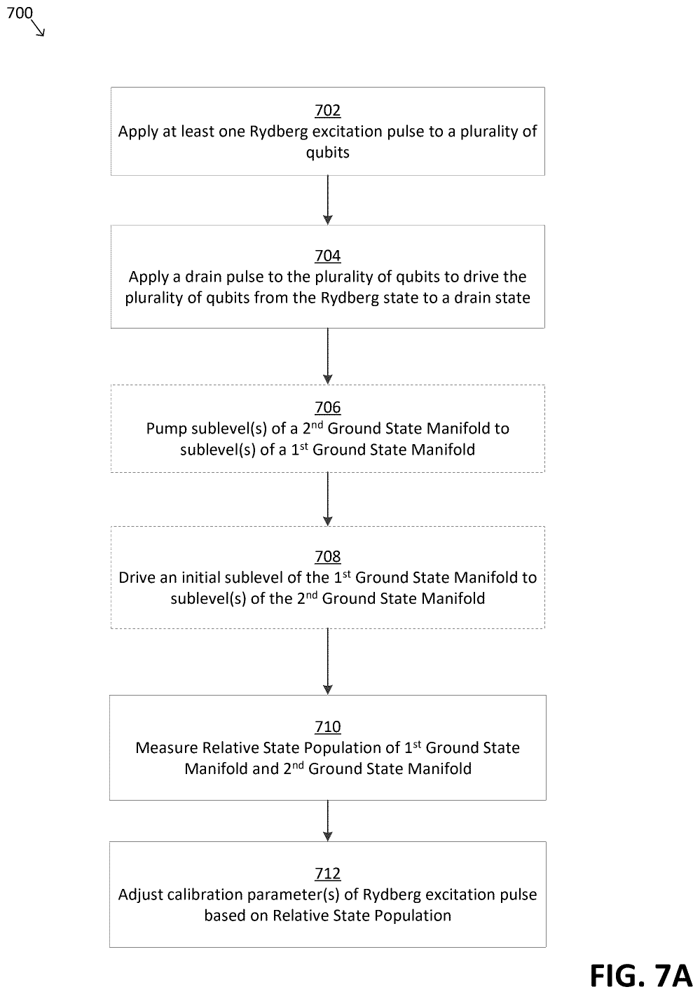

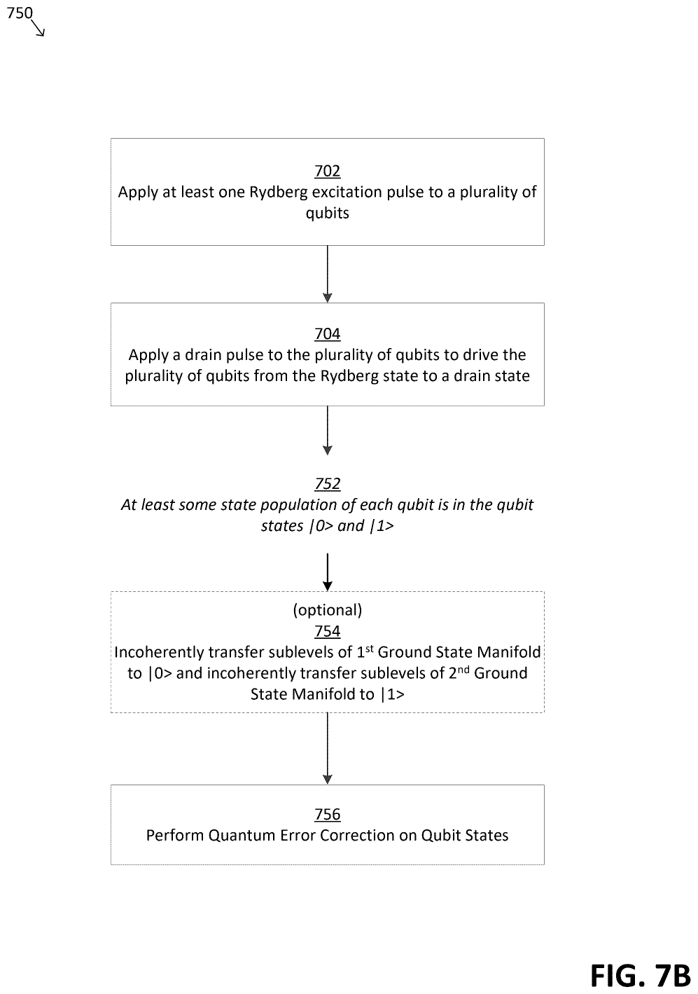

FIG. 7A is a flowchart of a method 700 for calibration Rydberg excitation pulses in a quantum information processor, in accordance with embodiments described herein. Method 700 may be performed by a suitable quantum information processor, such as quantum information processor 100 shown in FIG. 1 and described herein.

In act 702 of method 700, the quantum information processor performing method 700 applies a Rydberg excitation pulse to a plurality of qubits (e.g., as part of an entangling gate operation). In some embodiments, the qubits are neutral atoms held in an array of optical traps. The Rydberg excitation pulse is configured to drive the qubits between a ground state and a Rydberg state. As described above, the initial ground state may be a selected state of a ground state manifold (such as a Zeeman level within a hyperfine manifold of the atomic ground state).

The Rydberg excitation may be implemented using a sequence of laser pulses, for example, a two-photon transition, to selectively excite the desired qubits. During this step, the optical traps may be temporarily turned off to prevent anti-trapping effects on atoms in the Rydberg state. The Rydberg excitation pulse applied in act 702 may be configured with a duration that causes a transition between the initial ground state and the Rydberg state, as described above.

In act 704, which is performed subsequent to the application of the Rydberg excitation pulse(s) in act 702, the quantum information processor performing method 700 applied a drain pulse to the plurality of qubits. The drain pulse is configured to drive qubits from the Rydberg state to a drain state having a lower energy than the Rydberg state. In some embodiments, the drain pulse is a laser pulse with a wavelength resonant with the transition from the Rydberg state to the drain state. The drain state may be a short-lived excited state that decays rapidly, such as by spontaneous emission, to one or more ground states. The use of the drain pulse suppresses atom loss by transferring population out of the Rydberg state in a one-way process, thereby improving the reliability of subsequent measurements and enabling recycling of atoms for further operations. According to some embodiments, the drain pulse is shaped as a rapid adiabatic passage (RAP) pulse.

Subsequently to act 704, the state population in the drain state may decay (whether by being driven and/or through spontaneous emission) to one or more ground states. As described above in relation to FIG. 5, this may result, for a given qubit, in finite state populations within multiple sublevels of a first ground state manifold (e.g., 402) and within multiple sublevels of a second ground state manifold (e.g., 403).

In some embodiments, method 700 proceeds to act 710 in which the relative state population of the first ground state manifold and the second ground state manifold is measured. Act 710 may comprise illuminating the qubits with an imaging beam of a particular frequency and measuring fluorescence, as described above, which allows determination of which atoms are in a state that matches the selected frequency. In some embodiments, a readout system and detector of the quantum information processor performing method 700 are operated in act 706 to distinguish between atoms in the first ground state and those in other states, such as the drain state, other ground states, or residual excited states. The detection step provides information about the final state of each qubit following the entangling gate and drain pulse sequence.

As shown in the second subfigure of FIG. 5, measuring the relative state population of the two ground state manifolds at this stage may provide information on the calibration of the Rydberg excitation pulse, though with a comparatively lower signal to noise ratio than would be obtained by measuring the relative state populations in the arrangement shown in the fourth subfigure of FIG. 5.

As such, optionally, method 700 may include acts 706 and 708 in which the third and fourth operations shown in FIG. 5 are performed, respectively.

In act 712, one or more parameters associated with the Rydberg excitation pulse applied in act 702 are adjusted based on the relative state population measured in act 710. As described above, advantage of the techniques described herein is to allow an improved calibration of Rydberg excitation pulses. Performing acts 702 and 704 (and optionally acts 706 and 708) of method 700 may provide an indication of the accuracy of the calibration of the Rydberg excitation pulse applied in act 702 (e.g., since the relative state population measured in act 710 may be expected to increase in favor of a higher population in ground state manifold 403 as the accuracy improves). As such, act 710 may include adjusting one or more parameters of the Rydberg excitation pulse such as its duration, frequency, etc. based on the detected error state(s) in act 708. Such a process may be performed iteratively, with repeated instances of method 700 being performed to gradually improve the calibration.

FIG. 7B is a flowchart of a method 750 of correcting Rydberg errors in a quantum information processor, in accordance with embodiments described herein. Method 700 may be performed by a suitable quantum information processor, such as quantum information processor 100 shown in FIG. 1 and described herein.

Acts 702 and 704 of method 750 may be performed in any of the ways described above in relation to FIG. 7A.

Subsequent to act 704, at least some of the state population for a given qubit is in the qubit states |0 [symbol] and |1 [symbol] . For example, one of the sublevels of the ground state manifold 402 shown in FIG. 5 may be the |1 [symbol] qubit state, and one of the sublevels of the ground state manifold 403 may be the |0 [symbol] qubit state. Accordingly, as shown in the second subfigure of FIG. 5, at least some of the state population is, subsequent to the drain pulse being applied and the state population decaying to the ground states, in the qubit states |0 [symbol] and |1 [symbol] at step 752 of method 750.

While quantum error correction may be applied to such an arrangement, it may be desirable to increase the effectiveness of such operations by converting the leakage errors shown into depolarization errors by incoherently transferring the sublevels of each ground state manifold to its respective qubit level.

In the example of FIG. 7B, optional act 754 may be performed which incoherently transfers sublevels of the first ground state manifold (e.g., 402) to |0 [symbol] and incoherently transfers sublevels of the second ground state manifold to |1 [symbol] .

In some embodiments, act 754 comprises a process of dual-frequency optical pumping. This technique comprises directing light from two pi-polarized lasers of different frequencies onto a qubit to couple different states that over time cause a shift in the state populations—specifically, to shift sublevels in each ground state manifold into the qubit state in the ground state manifold.

For example, for ¹³³Cs, the two pi-polarized lasers are operated to couple F=3 to F′=3 and F=4 to F′=4, where primed states reside in the 6P1/2 level. Atomic selection rules prevent coupling |3,0> to |3′,0′> and prevent coupling |4,0> to |4′,0′>; these states are undisturbed by this dual optical pumping provided that the laser polarization is pure and the coupling is weak relative to the hyperfine splitting of the 6P1/2 level. Spontaneous emission from 6P1/2 back to 6S1/2 randomly populates the 6S1/2 sublevels (specifically, atoms can acquire delta m_{F}=0 or +/−1 in this decay, moving one step to the right or left or falling straight back down in the diagram above), so over time population will accumulate in the |3,0 [symbol] and |4,0 [symbol] ‘dark’ states—the qubit states.

Method 750 includes act 756 in which one or more corrective operations are performed on the qubits. As described above, another advantage of the techniques described herein is in correcting errors during operation (e.g., during execution of a quantum circuit). Unlike the lossy Rydberg detection process described above, the techniques described herein allow the correction of errors within loss of the atoms that produced an error. Act 756 may comprise any corrective action performed on those atoms, such as measuring stabilization codes and performing error correction operations based on such measurements.

The method illustrated in FIG. 7B therefore advantageously provides a robust and efficient approach for detecting and correcting errors associated with Rydberg excitation in neutral atom quantum processors. By incorporating a drain pulse and state-sensitive detection, the method minimizes atom loss and facilitates high-fidelity quantum operations. Each step of the flowchart is associated with a specific subsystem of the quantum information processor, including the control electronics, optical systems, and readout hardware, as described in further detail above.

Thus, the techniques described herein may improve calibration speeds for Rydberg-atom-based quantum computers or quantum sensors. Moreover, atom loss may be converted to atom state leakage. This may subsequently be converted to depolarization error using other techniques. Correction of depolarization error is the subject of a large body of literature on quantum error correction, and conversion of loss to depolarization allows application of these techniques to correct loss error.

Another application of the above-described techniques is to reduce correlated errors in entangling gates during operation of a neutral atom quantum computer. During operation, in some cases, entangling gates may be executed sequentially on pairs of atoms that are close enough for their Rydberg states to interact. In this case, if an error occurs in a first gate on a first pair, causing population to be left in the Rydberg state of one or both of the atoms in the first pair after the first gate, this unwanted residual Rydberg population can impact the dynamics of Rydberg excitation on a second nearby pair addressed by a second gate, causing a second error. By applying a drain pulse to each atom in the first pair after the first gate and before the second gate, this residual Rydberg population can be returned to the ground state, thereby reducing the probability of the error in the first gate causing an error in the second gate.

As referred to herein, a “qubit” includes any multi-level quantum-mechanical system capable of being controlled by a quantum information processor. The quantum states of the qubit may for instance include electronic states, polarization states, vibrational states, rotational states, or spin states.

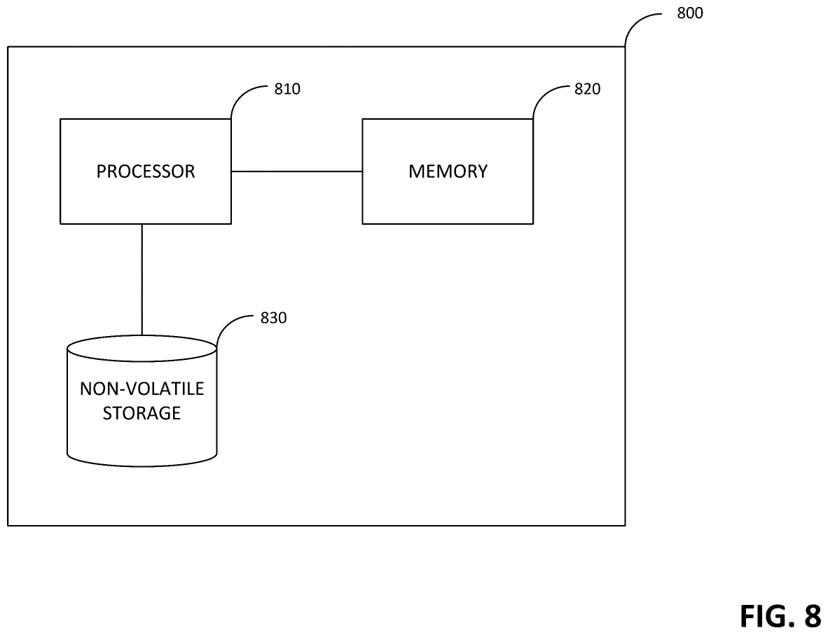

An illustrative implementation of a computer system 800 that may be used to control a quantum information processor to perform any of the techniques described above is shown in FIG. 8. The computer system 800 may include one or more processors 810 and one or more non-transitory computer-readable storage media (e.g., memory 820 and one or more non-volatile storage media 830). The one or more processors 810 may control writing data to and reading data from the memory 820 and the one or more non-volatile storage media 830 in any suitable manner, as the aspects of the disclosure described herein are not limited in this respect. To perform functionality and/or techniques described herein, the one or more processors 810 may execute one or more instructions stored in one or more computer-readable storage media (e.g., the memory 820, storage media, etc.), which may serve as non-transitory computer-readable storage media storing instructions for execution by the one or more processors 810.

In connection with techniques described herein, code used to, for example, operate an optical system, generate optical traps, operate lasers to perform a Rydberg excitation pulse, a drain pulse, etc. may be stored on one or more computer-readable storage media of computer system 800. The one or more processors 810 may execute any such code to perform any of the above-described techniques as described herein. Any other software, programs or instructions described herein may also be stored and executed by computer system 800. It will be appreciated that computer code may be applied to any aspects of methods and techniques described herein. For example, computer code may be applied to determine error states based on fluorescence measurements, etc.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present disclosure. The non-transitory computer-readable medium or media may be transportable, such that the program or programs stored thereon may be loaded onto any computer resource to implement various aspects of the present disclosure as described above.

The terms “program,” “software,” and/or “application” are used herein in a generic sense to refer to any type of computer code or set of computer-executable instructions that can be employed to program a computer or other processor to implement various aspects of embodiments as described above. Additionally, it should be appreciated that according to one aspect, one or more computer programs that when executed perform methods of the present disclosure need not reside on a single computer or processor, but may be distributed in a modular fashion among different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Having thus described several aspects of at least one embodiment of this disclosure, it is to be appreciated that various alterations, modifications, and improvements will readily occur to those skilled in the art. For instance, aspects of the techniques described herein may be combined in any of the following ways:
Example 1. A method comprising: using a quantum information processor: applying, to a plurality of qubits, at least one Rydberg excitation pulse configured to drive the plurality of qubits between a Rydberg state and an initial sublevel of a first ground state manifold of the plurality of qubits; applying, to the plurality of qubits subsequent to applying of the at least one Rydberg excitation pulse, a drain pulse configured to drive the plurality of qubits between the Rydberg state and a drain state having a lower energy than the Rydberg state; measuring a relative state population of the first ground state manifold and a second ground state manifold of the plurality of qubits; and adjusting at least one calibration parameter of the at least one Rydberg excitation pulse based on the relative state population.
Example 2. The method of example 1, further comprising, subsequent to applying the drain pulse and prior to measuring the relative state population: pumping one or more sublevels of the second ground state manifold to one or more sublevels of the first ground state manifold; and driving, subsequent to pumping the one or more sublevels of the second ground state manifold to the one or more sublevels of the first ground state manifold, the initial sublevel of the first ground state manifold to one or more sublevels of the second ground state manifold.
Example 3. The method of any of examples 1-2, wherein the first ground state manifold comprises a plurality of sublevels including the initial sublevel, and wherein the plurality of sublevels are a plurality of Zeeman sublevels.
Example 4. The method of any of examples 1-3, wherein the first ground state manifold and the second ground state manifold are respective ground state manifolds of an atomic ground state.
Example 5. The method of any of examples 1-4, wherein the first ground state manifold and the second ground state manifold are hyperfine manifolds of the atomic ground state.
Example 6. The method of any of examples 1-5, wherein the plurality of qubits are a plurality of neutral atoms.
Example 7. The method of any of examples 1-6, wherein the drain pulse comprises a laser pulse having a wavelength resonant with a transition from the Rydberg state to the drain state.
Example 8. The method of any of examples 1-7, wherein the drain pulse is shaped as a rapid adiabatic passage pulse.
Example 9. The method of any of examples 1-8, wherein the at least one Rydberg excitation pulse comprises a two-photon Rydberg excitation pulse.
Example 10. The method of any of examples 1-9, wherein applying the at least one Rydberg excitation pulse to the plurality of qubits comprises operating an optical system to direct one or more laser beams onto each of the plurality of qubits.
Example 11. The method of any of examples 1-10, wherein the plurality of qubits is a plurality of neutral atom qubits each held in one of a plurality of optical traps, and wherein one or more trap drop periods of the plurality of optical traps are performed while applying the at least one Rydberg excitation pulse.
Example 12. The method of any of examples 1-11, wherein the one or more trap drop periods end subsequent to applying the at least one Rydberg excitation pulse and prior to measuring the relative state population.
Example 13. The method of any of examples 1-12, wherein the at least one calibration parameter of the at least one Rydberg excitation pulse includes a duration and/or frequency of a laser pulse.
Example 14. A method comprising: using a quantum information processor: performing an entangling gate comprising applying, to a plurality of qubits, at least one Rydberg excitation pulse configured to drive the plurality of qubits between a Rydberg state and an initial sublevel of a first ground state manifold of the plurality of qubits; applying, to the plurality of qubits subsequent to applying of the at least one Rydberg excitation pulse, a drain pulse configured to drive the plurality of qubits between the Rydberg state and a drain state having a lower energy than the Rydberg state, wherein applying the drain pulse causes at least some state population of each of the plurality of qubits to be in qubit states and; and performing, subsequent to applying the drain pulse, at least one quantum error correction operation on the qubit states and of the plurality of qubits.
Example 15. The method of example 14, wherein the qubit state is a sublevel of the first ground state manifold, wherein the qubit state is a sublevel of a second ground state manifold, and wherein the method further comprises: subsequent to applying the drain pulse and prior to performing the at least one quantum error correction operation, applying at least one operation to the plurality of qubits configured to incoherently transfer sublevels of the first ground state manifold to the qubit state and to incoherently transfer sublevels of the second ground state manifold to the qubit state.
Example 16. The method of any of examples 14-15, wherein the at least one operation comprises dual-frequency optical pumping.
Example 17. The method of any of examples 14-16, wherein the dual-frequency optical pumping comprises directing light from two pi-polarized lasers of different frequencies onto the plurality of qubits.
Example 18. The method of any of examples 14-17, wherein the first ground state manifold comprises a plurality of sublevels including the initial sublevel, and wherein the plurality of sublevels are a plurality of Zeeman sublevels.
Example 19. The method of any of examples 14-18, wherein the first ground state manifold and the second ground state manifold are respective ground state manifolds of an atomic ground state.
Example 20. The method of any of examples 14-19, wherein the first ground state manifold and the second ground state manifold are hyperfine manifolds of the atomic ground state.
Example 21. The method of any of examples 14-20, wherein the plurality of qubits are a plurality of neutral atoms.
Example 22. The method of any of examples 14-21, wherein the drain pulse comprises a laser pulse having a wavelength resonant with a transition from the Rydberg state to the drain state.
Example 23. The method of any of examples 14-22, wherein the drain pulse is shaped as a rapid adiabatic passage pulse.
Example 24. The method of any of examples 14-23, wherein the at least one Rydberg excitation pulse comprises a two-photon Rydberg excitation pulse.
Example 25. The method of any of examples 14-24, wherein applying the at least one Rydberg excitation pulse to the plurality of qubits comprises operating an optical system to direct one or more laser beams onto each of the plurality of qubits.
Example 26. A system comprising: an optical system configured to trap, and manipulate quantum states of, a plurality of neutral atom qubits; and at least one controller configured to: apply, to the plurality of neutral atom qubits, at least one Rydberg excitation pulse configured to drive the plurality of neutral atom qubits between a Rydberg state and an initial sublevel of a first ground state manifold of the plurality of neutral atom qubits; apply, to the plurality of neutral atom qubits subsequent to applying of the at least one Rydberg excitation pulse, a drain pulse configured to drive the plurality of neutral atom qubits between the Rydberg state and a drain state having a lower energy than the Rydberg state; measuring a relative state population of the first ground state manifold and a second ground state manifold of the plurality of neutral atom qubits; and adjusting at least one calibration parameter of the at least one Rydberg excitation pulse based on the relative state population.
Example 27. The system of example 26, wherein the optical system comprises an array of optical tweezers configured to individually trap each neutral atom qubit.
Example 28. The system of any of examples 26-27, wherein the drain pulse comprises a laser pulse having a wavelength resonant with a transition from the Rydberg state to the drain state.
Example 29. The system of any of examples 26-28, wherein the at least one controller is configured to measure the relative state population by operating the optical system to direct light onto the plurality of neutral atom qubits, and detecting which of the plurality of neutral atom qubits generated fluorescence light in response to the light.
Example 30. The system of any of examples 26-29, wherein the drain pulse is shaped as a rapid adiabatic passage pulse.
Example 31. The system of any of examples 26-30, wherein the at least one Rydberg excitation pulse comprises a two-photon Rydberg excitation pulse.
Example 32. The system of any of examples 26-31, wherein the at least one controller is further configured to, subsequent to applying the drain pulse and prior to measuring the relative state population: pump one or more sublevels of the second ground state manifold to one or more sublevels of the first ground state manifold; and drive, subsequent to pumping the one or more sublevels of the second ground state manifold to the one or more sublevels of the first ground state manifold, the initial sublevel of the first ground state manifold to one or more sublevels of the second ground state manifold.
Example 38: A method, comprising applying a concatenated pulse to a plurality of quantum state carriers, the concatenated pulse including a Rydberg pulse and a drain pulse, the Rydberg pulse being configured to excite at least one quantum state carrier of the plurality of quantum state carriers from a first state to a Rydberg state, the drain pulse being configured to transition the at least one quantum state carrier from the Rydberg state to a drain state having a lower energy than the Rydberg state.
Example 39. The method of example 38, wherein the plurality of quantum state carriers includes a plurality of atoms.
Example 40. The method of any of examples 38-39, wherein the drain state is different from the first state, the first state being a ground state for the plurality of quantum state carriers.
Example 41. The method of any of examples 38-40, wherein the drain state has a low quantum state carrier loss rate.
Example 42. The method of any of examples 38-41, wherein the drain state is at least one of a quantum state carrier trappable state or a transfer state configured to allow transfer of the quantum state carrier to a trappable state.
Example 43. The method of any of examples 38-42, wherein the concatenated pulse further comprises an additional pulse after the drain pulse, the additional pulse being configured to transition the at least one quantum state carrier from the drain state to an additional state.
Example 44. The method of any of examples 38-43, wherein the Rydberg pulse includes a plurality of pulses configured to excite the at least one quantum state carrier from the first state to the Rydberg state.
Example 45. The method of any of examples 38-44, further comprising: detecting the at least one quantum state carrier based on the drain state.

Such alterations, modifications, and improvements are intended to be part of this disclosure and are intended to be within the spirit and scope of the disclosure. Further, though advantages of the present disclosure are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Aspects of the above-described embodiments of the technology described herein can be implemented in any of numerous ways. For example, aspects of the embodiments may be implemented using hardware, software, or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present disclosure may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, aspects of the disclosure may be embodied as a method, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method comprising:
using a quantum information processor:
applying, to a plurality of qubits, at least one Rydberg excitation pulse configured to drive the plurality of qubits between a Rydberg state and an initial sublevel of a first ground state manifold of the plurality of qubits;
applying, to the plurality of qubits subsequent to applying of the at least one Rydberg excitation pulse, a drain pulse configured to drive the plurality of qubits between the Rydberg state and a drain state having a lower energy than the Rydberg state;
measuring a relative state population of the first ground state manifold and a second ground state manifold of the plurality of qubits; and
adjusting at least one calibration parameter of the at least one Rydberg excitation pulse based on the relative state population.

2. The method of claim 1, further comprising, subsequent to applying the drain pulse and prior to measuring the relative state population:
pumping one or more sublevels of the second ground state manifold to one or more sublevels of the first ground state manifold; and
driving, subsequent to pumping the one or more sublevels of the second ground state manifold to the one or more sublevels of the first ground state manifold, the initial sublevel of the first ground state manifold to one or more sublevels of the second ground state manifold.

3. The method of claim 1, wherein the first ground state manifold comprises a plurality of sublevels including the initial sublevel, and wherein the plurality of sublevels are a plurality of Zeeman sublevels.

4. The method of claim 1, wherein the first ground state manifold and the second ground state manifold are respective ground state manifolds of an atomic ground state.

5. The method of claim 4, wherein the first ground state manifold and the second ground state manifold are hyperfine manifolds of the atomic ground state.

6. The method of claim 1, wherein the plurality of qubits are a plurality of neutral atoms.

7. The method of claim 1, wherein the drain pulse comprises a laser pulse having a wavelength resonant with a transition from the Rydberg state to the drain state.

8. The method of claim 1, wherein the drain pulse is shaped as a rapid adiabatic passage pulse.

9. The method of claim 1, wherein the at least one Rydberg excitation pulse comprises a two-photon Rydberg excitation pulse.

10. The method of claim 1, wherein applying the at least one Rydberg excitation pulse to the plurality of qubits comprises operating an optical system to direct one or more laser beams onto each of the plurality of qubits.

11. The method of claim 1, wherein the plurality of qubits is a plurality of neutral atom qubits each held in one of a plurality of optical traps, and wherein one or more trap drop periods of the plurality of optical traps are performed while applying the at least one Rydberg excitation pulse.

12. The method of claim 11, wherein the one or more trap drop periods end subsequent to applying the at least one Rydberg excitation pulse and prior to measuring the relative state population.

13. The method of claim 1, wherein the at least one calibration parameter of the at least one Rydberg excitation pulse includes a duration and/or frequency of a laser pulse.

14. A method comprising:
using a quantum information processor:
performing an entangling gate comprising applying, to a plurality of qubits, at least one Rydberg excitation pulse configured to drive the plurality of qubits between a Rydberg state and an initial sublevel of a first ground state manifold of the plurality of qubits;
applying, to the plurality of qubits subsequent to applying of the at least one Rydberg excitation pulse, a drain pulse configured to drive the plurality of qubits between the Rydberg state and a drain state having a lower energy than the Rydberg state, wherein applying the drain pulse causes at least some state population of each of the plurality of qubits to be in qubit states |0 [symbol] and |1 [symbol] ; and
performing, subsequent to applying the drain pulse, at least one quantum error correction operation on the qubit states |0 [symbol] and |1 [symbol] of the plurality of qubits.

15. The method of claim 14, wherein the qubit state |0 [symbol] is a sublevel of the first ground state manifold, wherein the qubit state |1 [symbol] is a sublevel of a second ground state manifold, and wherein the method further comprises:
subsequent to applying the drain pulse and prior to performing the at least one quantum error correction operation, applying at least one operation to the plurality of qubits configured to incoherently transfer sublevels of the first ground state manifold to the qubit state |0 [symbol] and to incoherently transfer sublevels of the second ground state manifold to the qubit state |1 [symbol] .

16. The method of claim 15, wherein the at least one operation comprises dual-frequency optical pumping.

17. The method of claim 16, wherein the dual-frequency optical pumping comprises directing light from two pi-polarized lasers of different frequencies onto the plurality of qubits.

18. The method of claim 14, wherein the first ground state manifold comprises a plurality of sublevels including the initial sublevel, and wherein the plurality of sublevels are a plurality of Zeeman sublevels.

19. The method of claim 15, wherein the first ground state manifold and the second ground state manifold are respective ground state manifolds of an atomic ground state.

20. The method of claim 19, wherein the first ground state manifold and the second ground state manifold are hyperfine manifolds of the atomic ground state.

21. The method of claim 14, wherein the plurality of qubits are a plurality of neutral atoms.

22. The method of claim 14, wherein the drain pulse comprises a laser pulse having a wavelength resonant with a transition from the Rydberg state to the drain state.

23. The method of claim 14, wherein the drain pulse is shaped as a rapid adiabatic passage pulse.

24. The method of claim 14, wherein the at least one Rydberg excitation pulse comprises a two-photon Rydberg excitation pulse.

25. The method of claim 14, wherein applying the at least one Rydberg excitation pulse to the plurality of qubits comprises operating an optical system to direct one or more laser beams onto each of the plurality of qubits.

26. A system comprising:
an optical system configured to trap, and manipulate quantum states of, a plurality of neutral atom qubits; and
at least one controller configured to:
apply, to the plurality of neutral atom qubits, at least one Rydberg excitation pulse configured to drive the plurality of neutral atom qubits between a Rydberg state and an initial sublevel of a first ground state manifold of the plurality of neutral atom qubits;
apply, to the plurality of neutral atom qubits subsequent to applying of the at least one Rydberg excitation pulse, a drain pulse configured to drive the plurality of neutral atom qubits between the Rydberg state and a drain state having a lower energy than the Rydberg state;
measuring a relative state population of the first ground state manifold and a second ground state manifold of the plurality of neutral atom qubits; and
adjusting at least one calibration parameter of the at least one Rydberg excitation pulse based on the relative state population.

27. The system of claim 26, wherein the optical system comprises an array of optical tweezers configured to individually trap each neutral atom qubit.

28. The system of claim 26, wherein the drain pulse comprises a laser pulse having a wavelength resonant with a transition from the Rydberg state to the drain state.

29. The system of claim 26, wherein the at least one controller is configured to measure the relative state population by operating the optical system to direct light onto the plurality of neutral atom qubits, and detecting which of the plurality of neutral atom qubits generated fluorescence light in response to the light.

30. The system of claim 26, wherein the drain pulse is shaped as a rapid adiabatic passage pulse.

31. The system of claim 26, wherein the at least one Rydberg excitation pulse comprises a two-photon Rydberg excitation pulse.

32. The system of claim 26, wherein the at least one controller is further configured to, subsequent to applying the drain pulse and prior to measuring the relative state population:
pump one or more sublevels of the second ground state manifold to one or more sublevels of the first ground state manifold; and
drive, subsequent to pumping the one or more sublevels of the second ground state manifold to the one or more sublevels of the first ground state manifold, the initial sublevel of the first ground state manifold to one or more sublevels of the second ground state manifold.
